(19) United States
(12) Patent Application Publication
(10) Pub. No.: US 2006/0194187 A1
(43) Pub. Date: Aug. 31, 2006

(54) Material processing apparatus, material processing method, and program product

(75) Inventor: Teruka Saito, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd.

(21) Appl. No.: 11/222,762

(22) Filed: Sep. 12, 2005

(30) Foreign Application Priority Data
Feb. 28, 2005 (JP) P2005-052480

(51) Int. Cl. G09B 7/00; G09B 3/00

(52) U.S. Cl. 434/353

(57) ABSTRACT

A material processing apparatus includes: a reading unit that reads image on materials each having an entry field; an extracting unit that compares image data for one material on which a content of the entry field is entered with image data for one material on which a content of the entry field is not entered, and extracts a difference between the image data; a calculating unit that calculates position information for the entry field from an extracted result by the extracting unit; a memory that stores a result calculated by the calculating unit; a recognizing unit that extracts a content of the entry of the correct/incorrect determination with respect to the entry of the entry field from the image data; and a point totaling unit that performs point totaling of the correct/incorrect determination entered on the material based on a stored content and the extracted result.

### BACKGROUND OF THE INVENTION

1. Field of the Invention

The present invention relates to a material processing apparatus which handles educational teaching materials to be used in educational institutes, to a material processing method, and to a teaching material processing program product. More particularly, the present invention relates to a material processing apparatus which performs grading on the educational teaching materials, to a material processing method, and to a teaching material processing program product.

2. Background Art

Generally, in educational institutes, such as schools or private schools, there are many cases in which educational teaching materials, such as test papers or sheets for exercises, are used. That is, it has been widely known that, with a teaching material having questions and answer fields, a pupil enters answers on the teaching material, and a teacher grades the entered answers.

As regards the teaching materials, simplification of grading is strongly demanded. Accordingly, a system has been suggested in which, in order to realize simplification of grading, for example, a grading board and a grading pen are connected to a personal computer (hereinafter, referred to as ‘PC’) and grading is performed with the grading pen in a state in which a teaching material is positioned at a predetermined position of the grading board. In this system, position information and right/wrong information of the answers entered on the teaching material are inputted to the PC, such that automatic grading is performed on the answers on the teaching material by means of the PC.

However, it is not necessarily desirable that, at the time of grading the teaching material, dedicated constituent devices, such as the grading board, the grading pen, and the like, need to be provided. This is because the dedicated constituent devices cause the complex configuration of the entire system or high costs.

Accordingly, the present invention provides a teaching material processing apparatus which can perform totaling of automatic grading on the content of the entry of right or wrong determination to a teaching material to be used in an educational institute while reducing trouble of information input, thereby realizing simplification of grading, a teaching material processing method, and a teaching material processing program product.

### SUMMARY OF THE INVENTION

According to one aspect of the invention, a material processing apparatus includes: a reading unit that performs image reading on materials each having an entry field, to obtain image data from the materials; an extracting unit that compares image data for one material on which a content of the entry field is entered with image data for one material on which a content of the entry field is not entered, and extracts a difference between the image data; a calculating unit that calculates position information for the entry field existing on the material from an extracted result by the extracting unit; a memory that stores a result calculated by the calculating unit; a recognizing unit that extracts a content of the entry of the correct/incorrect determination with respect to the entry of the entry field from the image data obtained by the reading unit; and a point totaling unit that performs point totaling of the correct/incorrect determination entered on the material based on a stored content by the memory and the extracted result by the recognizing unit.

According to another aspect of the invention, a material processing method includes: reading image on materials each having an entry field, to obtain image data from the materials; comparing image data for one material on which a content of the entry field is entered with image data for one material on which a content of the entry field is not entered; extracting a difference between the image data; calculating position information for the entry field existing on the material from an extracted result in the extracting step; storing a result calculated in the calculating step; extracting a content of the entry of the correct/incorrect determination with respect to the entry of the entry field from the image data obtained in the reading step; and performing point totaling of the correct/incorrect determination entered on the material based on a stored content in the storing step and the extracted result in the step of extracting the content of the entry of the correct/incorrect determination.

According to another aspect of the invention, a storage medium readable by a computer, stores a program of instructions executable by the computer to perform a function. The function includes: reading image on materials each having an entry field, to obtain image data from the materials; comparing image data for one material on which a content of the entry field is entered with image data for one material on which a content of the entry field is not entered; extracting a difference between the image data; calculating position information for the entry field existing on the material from an extracted result in the extracting step; storing a result calculated in the calculating step; extracting a content of the entry of the correct/incorrect determination with respect to the entry of the entry field from the image data obtained in the reading step; and performing point totaling of the correct/incorrect determination entered on the material based on a stored content in the storing step and the extracted result in the step of extracting the content of the entry of the correct/incorrect determination.

### BRIEF DESCRIPTION OF THE DRAWINGS

Embodiments of the present invention will be described in detail based on the following figures, wherein:

FIG. 1 is a block diagram schematically showing a structure of a teaching material processing apparatus according to the invention.

FIG. 2 is a diagram illustrating a specific example of a teaching material.

FIG. 3 is a block diagram showing a functional structure of an answer position point recognizing unit of the teaching material processing apparatus according to the invention.

FIGS. 4A-4C are diagrams illustrating an example of a difference extracting process executed when an answer/point correspondence information is recognized.

FIG. 5 is a first diagram illustrating an example of a grouping process executed when an answer/point correspondence information is recognized.

FIG. 6 is a second diagram illustrating an example of a grouping process executed when an answer/point correspondence information is recognized.

FIG. 7 is a third diagram illustrating an example of a grouping process executed when an answer/point correspondence information is recognized.

FIG. 8 is a fourth diagram illustrating an example of a grouping process executed when an answer/point correspondence information is recognized.

FIGS. 9A-9B are diagrams illustrating an example of an answer field position information calculating process executed when an answer/point correspondence information is recognized.

FIG. 10 is a diagram illustrating the process operation of a point totaling process in a teaching material processing apparatus according to the invention.

FIGS. 11A-11B are a flowchart and a diagram illustrating an example of an disconnection correcting process.

FIG. 12A-12B are a flowchart and a diagram illustrating another example of an disconnection correcting process.

FIG. 13 is a flowchart illustrating an example of a recognizing process sequence of the entry position of right or wrong extermination.

FIG. 14 is a flowchart illustrating an example of a process sequence of point totaling of right or wrong extermination.

FIG. 15 is a diagram illustrating a specific example of a grading result for each question.

FIG. 16 is a first diagram illustrating the outline of a recognition example of a difference between properties of entry fields.

FIG. 17 is a second diagram illustrating the outline of a recognition example of a difference between properties of entry fields.

### DETAILED DESCRIPTION OF THE PREFERRED EMBODIMENTS

Hereinafter, a teaching material processing apparatus, a teaching material processing method, and a teaching material processing program according to the invention will be described with reference to the accompanying drawings.

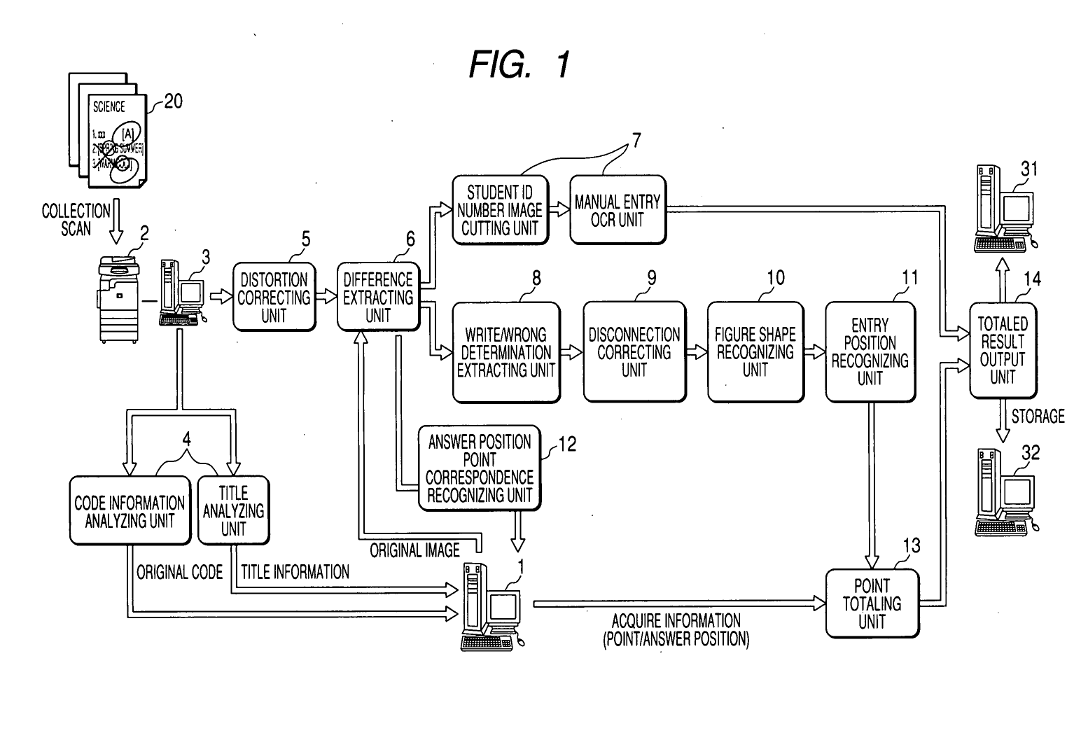

First, a schematic structure of the teaching material processing apparatus will be described. FIG. 1 is a block diagram showing the schematic structure of the teaching material processing apparatus according to the invention.

As shown in FIG. 1, the teaching material processing apparatus described herein includes a database unit 1, an image reading unit 2, an image data analyzing unit 3, a teaching material discriminating unit 4, a distortion correcting unit 5, a difference extracting unit 6, an answerer extracting unit 7, a right/wrong determination extracting unit 8, an disconnection correcting unit 9, a figure shape recognizing unit 10, an entry position recognizing unit 11, an answer position/allotted point recognizing unit 12, a point totaling unit 13, and a totaled result output unit 14.

The database unit 1 holds and accumulates electronic data for teaching materials. Further, the database unit 1 stores and holds answer/point correspondence information, which will be described in more detail below, in a state in which the answer/point correspondence information is associated with the respective teaching materials whose electronic data is held and accumulated. That is, the database unit 1 functions as a storage means of the invention.

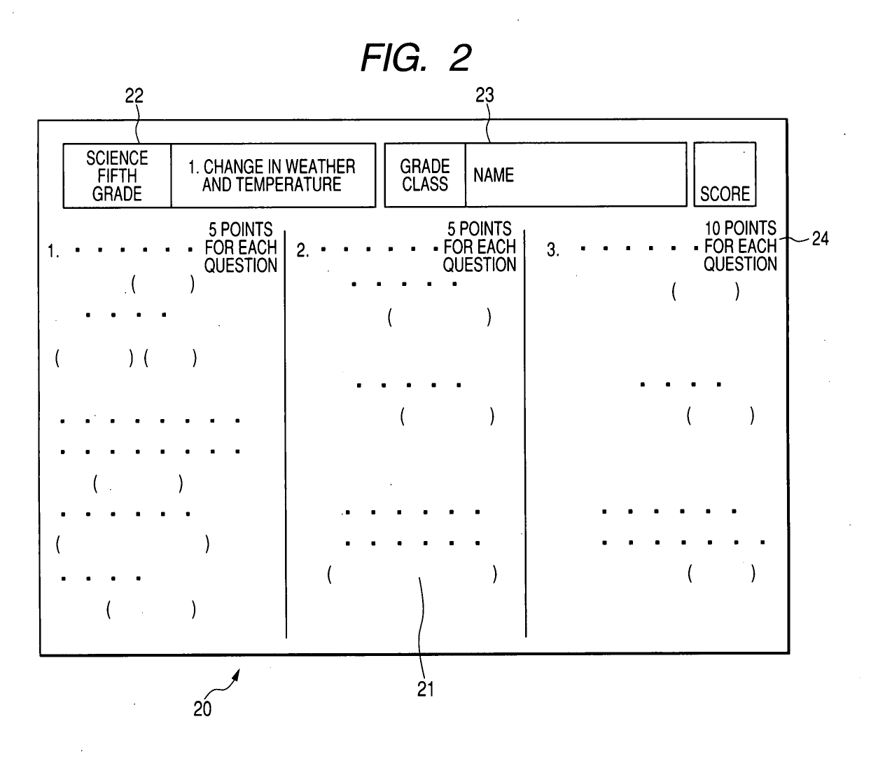

Here, the teaching material will be briefly described. FIG. 2 is a diagram illustrating a specific example of the teaching material. As shown in FIG. 2, the educational teaching material 20 has entry fields for problems and an entry field for an answerer. Specifically, the educational teaching material 20 corresponds to test papers, sheets for exercises or the like used in educational institutions. However, in the educational teaching material 20, answers may not necessarily entered for questions.

As entry fields, answer entry fields (hereinafter, simply referred to as ‘answer fields’) 21, in which answers are entered for questions, may be exemplified.

In addition, the educational teaching material 20 includes an identification information field 22 for identifying and specifying the teaching material and an answerer information field 23 for an answerer who enters answers on the answer fields 21. For example, in the identification information field 22, a subject, a title, an applicable grade or the like of the teaching material are entered in advance. In addition to the information entry or separately from the information entry, code information for identifying the educational teaching material 20 may be embedded. The embedment of the code information may be achieved by using known technologies. As one specific example of the known technologies, a technology may be used, in which as called ‘iTone (registered trademark)’, by changing forms of pixels constituting a multi-line screen or a dot screen as gray scale representation (positions or shapes), digital information is embedded in a half tone image. On the other hand, the answerer information field 23 is entered with a class, a student ID number, a name or the like of the answerer. That is, the answerer information field 23 is an entry field in which information having a different property from the answer field 21 is entered.

In addition, the educational teaching material 20 has point information 24 for the answer fields 21. The point information 24 is information for specifying the point with respect to the answer field 21 and is information in which ‘a figure’ and characters of ‘a point’ corresponding to the point are entered. That is, the point information 24 is information to specify the respective points with respect to the respective answer fields 21 existing on the teaching material. As long as the point information 24 can specify the point, it is not limited to ‘a figure’ and characters of ‘a point’, but may be composed of predetermined code information. In addition, the point information 24 may be individually arranged to correspond to each of the answer fields 21 existing on the educational teaching material 20 or may be collectively arranged for some answer fields 21 of which the points are equal. Even in any case, the point information 24 are regularly arranged near the answer fields 21 such that a correspondence relationship between the point information and the answer fields 21 each of which the point is specified by the point information 24 is clear (for example, arranged near the end of the question).

The electronic data for the educational teaching material 20 serves to specify the answer fields 21, the identification information field 22, the point information 24 or the layout of the answer fields 21, the identification information field 22, and the point information 24 in the educational teaching material 20. In addition, if the electronic data can be held and accumulated in the database unit 1, the data type of the electronic data is not limited. Specifically, it is considered that image data of a raster type read out by the image reading unit 2, which will be described in more detail below, is stored and held as the electronic data for the educational teaching material 20.

In FIG. 1, the image reading unit 2 performs the image reading using a known optical image reading technology with respect to the educational teaching material 20 to be read out, and then obtains image data from the educational teaching material 20. Specifically, the image reading unit 2 functions as a reading means of the invention. The educational teaching material 20 to be read out is a teaching material in which the entry of the answers in the answer fields 21, the entry of the name in the answerer information field 23, and the entry of the right or wrong determination with respect to the answer (specifically, a figure of ‘o’ or ‘x’) are made and the entry of the respective fields 21 and 23 is not made yet (hereinafter, referred to as ‘original copy’). In addition, a teaching material, in which even though the entry of the answer in the answer field 21 is made, the entry of the right or wrong determination is not made, (hereinafter, referred to as ‘model answer’), also becomes a reading subject by the image reading unit 2.

The image data analyzing unit 3 performs an analyzing process with respect to the image data obtained by the image reading unit 2. Examples of the analyzing process may includes layout analyzing, character and figure separation, character recognition, code information recognition, figure processing, color component recognition or the like. Since all the examples of the analyzing process can be achieved by the known image processing technology, the detailed description thereof will be omitted.

The teaching material discriminating unit 4 is composed of at least one of a title analyzing unit and a code information analyzing unit. The teaching material discriminating unit 4 identifies and specifies the educational teaching material 20 becoming a source of the image data obtained by the image reading unit 2 based on a result of the analyzing process in the image data analyzing unit 3, specifically, at least one result of the title analyzing by the title analyzing unit and the code analyzing by the code information analyzing unit with respect to the identification information field 22. At this time, the teaching material discriminating unit 4 compares the read out educational teaching material 20 with the teaching material whose electronic data is held and accumulated by the database unit 1, and determines that if the corresponding electronic data is not held and accumulated in the database unit 1, the identification specification of the teaching material is erroneous.

The distortion correcting unit 5 functions as a distortion correcting means of the invention to perform correction of the image distortion with respect to the image data obtained by the image reading unit 2. Examples of the image distortion correction may include tilt correction or expansion and contraction correction in a main-scanning direction or sub-scanning direction. However, since anyone of the examples of the image distortion correction can be achieved by using the known image processing technology, the detailed description thereof will be omitted.

The difference extracting unit 6 compares the data obtained after performing the image distortion correcting process by the distortion correcting unit 5 with respect to the image data obtained by the image reading unit 2 with the electronic data, which becomes the comparison subject and is stored in the database unit 1, based on the result of the identification specification of the educational teaching material 20 in the teaching material discriminating unit 4, and extracts the difference between them. In addition, the difference extracting unit 6 can perform the difference extraction using the temporary storing process of the image data with respect to the difference between the image data obtained from the educational teaching material 20 in which the entry of the right or wrong determination is made with respect to the answers or the educational teaching material 20 becoming an model answer, and the image data obtained from the educational teaching material 20 becoming the original copy, that is, the difference between the image data obtained by the image reading unit 2. If the electronic data for the model answer or the original copy is held in the database unit 1, the difference extracting unit 6 may extract the difference using the data obtained by perform the raster process with respect to the electronic data held in the database unit 1 without using the image data obtained by the image reading unit 2. That is, the difference extracting unit 6 functions as an additionally entered information extracting means in the invention. In addition, since the difference extraction process method can be achieved by using the known image process technology, the detailed description thereof will be omitted.

The answer extracting unit 7 is composed of at least one of an attendant number information extracting unit and a manual entry OCR (optical character reader) unit, preferably, is composed of both of them. The answer extracting unit 7 extracts the answerer information in the educational teaching material 20 becoming the reading subject in the image reading unit 2 through the character information extraction by the attendant number information extracting unit or the character recognizing process by the manual entry OCR unit with respect to the difference for the answerer information field 23 among the differences extracted by the difference extracting unit 6 based on the result of the analyzing process in the image data analyzing unit 3. Examples of the answerer information may include information, such as a class, an attendant number, a name or the like of the answerer, which identifies the answerer.

The right/wrong determination extracting unit 8 further extracts contents of the entry of a right or wrong determination from the differences extracted by the difference extracting unit 6, based on the result of the analyzing process by the image data analyzing unit 3. The extraction of the content of the entry of the right or wrong determination may be performed by extracting one for the a predetermined color component through the color component recognizing process with respect to the extraction result in the difference extracting unit 6. Generally, the entry of the right or wrong determination is performed by using a red color.

The disconnection correcting unit 9 performs the disconnection correction process with respect to the extraction result in the right/wrong determination extracting unit 8. The disconnection correction process is a process for connecting the extracted line segments and resolving the disconnection between the extracted line segments.

The figure shape recognizing unit 10 performs the shape recognition with respect to the content of the entry of the right or wrong determination which is extracted by the right/wrong determination extracting unit 8 and in which the disconnection correction is performed in the disconnection correcting unit 9, and recognizes the content of the entry of the right or wrong determination. The shape recognition may be performed by the pattern matching with the figure shape of the ‘o’ or ‘x’. That is, the figure shape recognizing unit 10 recognizes whether the content of the entry of the right or wrong determination is ‘correct (o)’ or ‘incorrect (x)’.

In addition, the entry position recognizing unit 11 recognizes the entry position on the educational teaching material 20 with respect to the content of the entry of the right or wrong determination whose shape is recognized in the figure shape recognizing unit 10. The recognition of the entry position may be performed by coordinate analysis on the teaching material.

That is, the figure shape recognizing unit 10 and the entry position recognizing unit 11 functions as the right/wrong determination recognizing means in the invention.

The answer position/allotted point recognizing unit 12 calculates the position information for the answer fields 21 on the educational teaching material 20 to specify them, based on the difference extraction result by the difference extracting unit 6. Further, the answer position/allotted point recognizing unit 12 recognizes the point with respect to the answer field 21 whose the position information is specified, and stores and holds these position information of the answer field 21 and the point information 24 in the database unit 1 as answer/point correspondence information by associating the position information of the answer field 21 and the point information 24 with each other. That is, the answer position/allotted point recognizing unit 12 specifies the respective positions and points with respect to the respective answer fields 21 existing on the educational teaching material 20. In addition, the answer position/allotted point recognizing unit 12 will be described in more detail below.

The point totaling unit 13 performs the point totaling of the right or wrong determination entered on the educational teaching material 20 with respect to the educational teaching material 20 of which the image reading is performed by the image reading unit 2, based on the recognition result of the content of the entry of the right or wrong determination by the figure shape recognizing unit 10, the recognition result of the entry position of the right or wrong determination by the entry position recognizing unit 11, and the answer/point correspondence information stored and held in the database unit 1. That is, the point totaling unit 13 functions as the point totaling means in the invention.

The totaled result output unit 14 outputs the result of the point totaling by the point totaling unit 13 by associating the result of the point totaling by the point totaling unit 13 with the answer information extracted by the answerer extracting unit 7. In addition, the output destination of the totaled result output unit 14 is the database device 31 connected to the teaching material processing apparatus and the file server device 32, which manage the grading totaled result with respect to the teaching material.

In addition, it is considered that the image reading unit 2 among the above-mentioned respective units 1 to 14 is achieved by using the a copy machine, a multi-functional machine or a scanner device functioning as the image reading device. In this case, if an automatic document feeder (ADF) is additionally provided, it is possible to continuously perform the image reading with respect to the plurality of teaching materials.

In addition, it is considered that the other units 1 and 3 to 14 other than the image reading unit 2 are achieved by using a computer device like a PC capable of achieving an information storage processing function, an image processing function, and an operation processing function by executing a predetermined program. In this case, it is considered that the predetermined program necessary for implementing the respective units 1 and 3 to 14 is installed in the PC in advance, but the invention is not limited thereto. That is, the predetermined program may be stored on a recording medium readable by the computer or may be distributed through a wire or wireless communication means without being installed in the PC in advance. The teaching material processing apparatus having the above-mentioned structure can be achieved by a teaching material processing program for making a computer connected to the image reading device function as a teaching material processing apparatus.

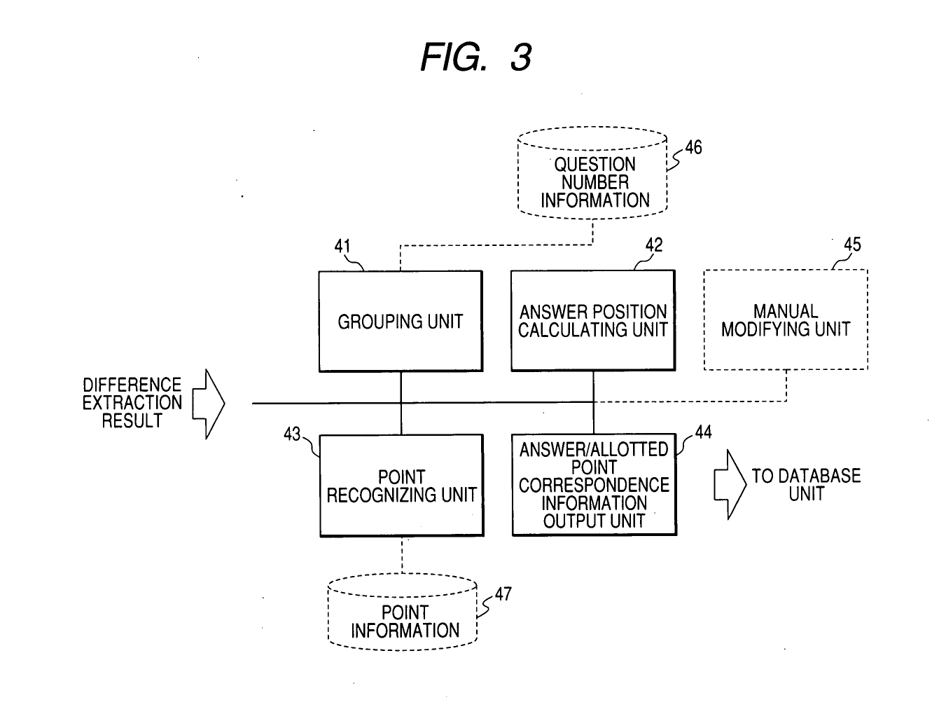

Here, the answer position/allotted point recognizing unit 12 among the above-mentioned respective units 1 to 14 will be described in more detail. FIG. 3 is a block diagram illustrating an example of a functional configuration of the answer position/allotted point recognizing unit 12. As shown in FIG. 3, the answer position/allotted point recognizing unit 12 includes a grouping unit 41, an answer position calculating unit 42, a point recognizing unit 43, and an answer/allotted point correspondence information output unit 44. The answer position/allotted point recognizing unit 12 further may include a manual modifying unit 45. In addition, when at least one of question number information 46 and point information 47 is prepared in the database unit 1 in advance, it may be constructed such that the question number information 46 or the point information 47 may be obtained. Further, the question number information 46 and the point information 47 will be described in more detail below.

The grouping unit 41 performs grouping to classify the extraction result in accordance with a predetermined rule with respect to the extraction result of the difference by the difference extracting unit 6, that is, the extraction result of the difference between the image data obtained from the educational teaching material 20 in which the entry of the right or wrong determination with respect to the answer is made or the educational teaching material 20 becoming the model answer and the image data obtained from the educational teaching material 20 becoming the original copy. In addition, when the question number information 46 is obtained, the grouping unit 41 may restrict the number of grouping in accordance with the question number information 46.

The answer position calculating unit 42 calculates the position information of each group on the educational teaching material 20 with respect to one obtained after performing the grouping process by the grouping unit 41 using the extraction result of the difference by the difference extraction unit 6. That is, the answer position calculating unit 42 functions as an answer position calculating means for calculating the position information for the answer fields 21 existing on the educational teaching material 20. In addition, the answer position calculating unit 42 recognizes the difference between the properties of the entry fields 21 and 23 existing on the educational teaching material 20 specified from the difference, based on the predetermined data component (for example, color data component) among the differences extracted by the difference extracting unit 6. Further, the answer position calculating unit 42 may calculate the position information for the answerer information field 23, in addition to the position information for the answer fields 21.

The point recognizing unit 43 recognizes the point with respect to the answer field 21 whose position information is calculated by the answer position calculating unit 42. It is considered that the recognition of the point is performed by using the point information 24 existing on the educational teaching material 20. However, when the point information 47 is obtained from the database unit 1, it is also considered that the recognition of the point is performed by using the point information 47.

The answer/allotted point correspondence information output unit 44 associates the calculated result by the answer position calculating unit 42 with the recognition result by the point recognizing unit 43, that is, associates the position information for the answer fields 21 existing on the educational teaching material 20 with the point with respect to the answer fields 21, outputs it as the answer/point correspondence information, and makes the answer/point correspondence information stored and held in the database unit 1.

The manual modifying unit 45 is for a user of the teaching material processing apparatus to modify the calculated result by the answer position calculating unit 42 and the recognition result by the point recognizing unit 43, if necessary. In addition, since the manual modifying unit 45 is not an essential constituent element, it may not be provided.

Next, a process operation example of the teaching material processing apparatus having the above-mentioned structure (including a case of being achieved by the teaching material processing program), that is, a sequence of the teaching material processing method according to the invention will be described.

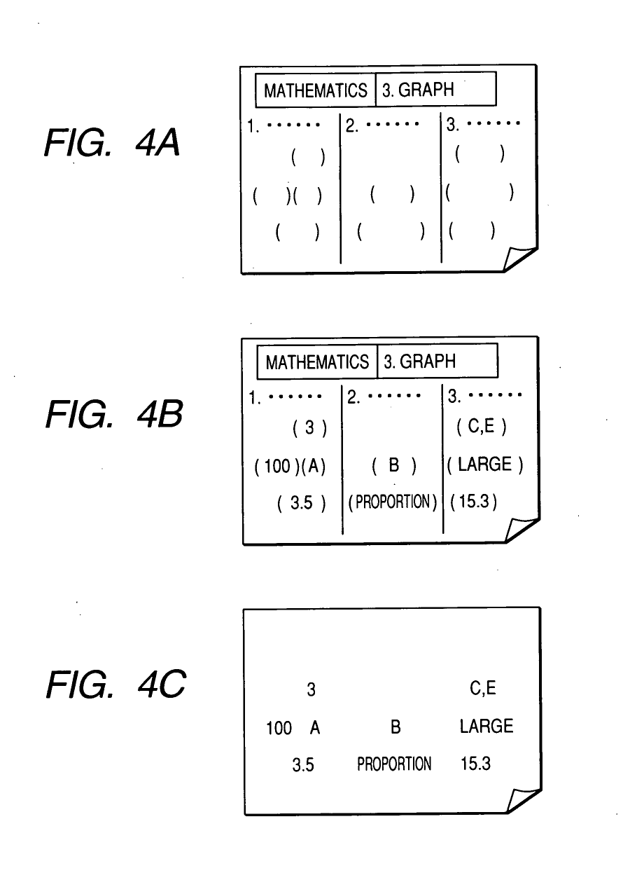

When the teaching material processing apparatus is used, a process is first performed for recognizing the answer/point correspondence information and storing and holding it in the database unit 1. FIGS. 4 to 9 are diagrams schematically illustrating the process operation example.

In the process for storing and holding the answer/point correspondence information, as shown in FIG. 4A, an original copy of the educational teaching material 20, that is, a educational teaching material 20 that the entry of answer fields 21 and answerer information field 23 is not made and the entry of right or wrong determination with respect to the answers is not made is arranged, and image reading by the image reading unit 2 is performed with respect to the educational teaching material 20. Thereby, the teaching material processing apparatus can obtain the image data from the educational teaching material 20. In addition, if the electronic data for the educational teaching material 20 that becomes the image reading subject is held in the database unit 1, one obtained by performing a raster process with respect to the electronic data held in the database unit 1 rather than the image data obtained by the image reading unit 2 may be used. In addition, when the electronic data does not exist in the database unit 1, a process, which will be described in more detail, is performed using image data obtained by the image reading unit 2. However, it is preferable that the image data be held and accumulated in the database unit 1 as the electronic data with respect to the educational teaching material 20 and be then used at the time of the point totaling process.

In addition, in addition to obtaining of the image data with respect to the original copy, as shown in FIG. 4B, with respect to the educational teaching material 20 in which the entry of the answers with respect to the answer fields 21 is made, the image reading by the image reading unit 2 is performed. Thereby, the teaching material processing apparatus obtains the image data from the educational teaching material 20 with respect to the educational teaching material 20 in which the entry of the answers with respect to the answer fields 21 is made as well as the original copy. At this time, it is preferable that the model answer be used as the educational teaching material 20 becoming the reading subject. If the answer is the model answer, the entry omission of the answers does not exist. In addition, if the model answer is printed, it is possible to improve the precision of the process performed subsequent to it. In the answer field 21 of the model answer, a predetermined mark, such as a rectangle grading not the model answer may be entered. A case in which the image data is obtained from the model answer will now be described. In addition, if the electronic data is held in the database unit 1 for the model answer, one obtained by performing the raster process with respect to the electronic data held in the database unit 1 other than the image data obtained by the image reading unit 2 may be used.

If the respective image data with respect to the original copy and the model answer is obtained, in the teaching material processing apparatus, the image data analyzing unit 3 performs an analyzing process with respect to the respective image data, and then the distortion correcting unit 5 corrects the image distortion in the respective image data. The correction of the image distortion is preformed for correcting the image distortion occurring when the image is read out by the image reading unit 2. In addition, the difference extracting unit 6 compares the respective image data with each other after the image distortion correcting process by the distortion correcting unit 5, and the difference is then extracted, as shown in FIG. 4C. Through the difference extraction, the content entered in the answer fields 21 is extracted.

After that, the answer position/allotted point recognizing unit 12 calculates the position information for the answer fields 21 from the difference extracting result by the difference extracting unit 6 and performs the recognition of the points corresponding to the answer fields 21.

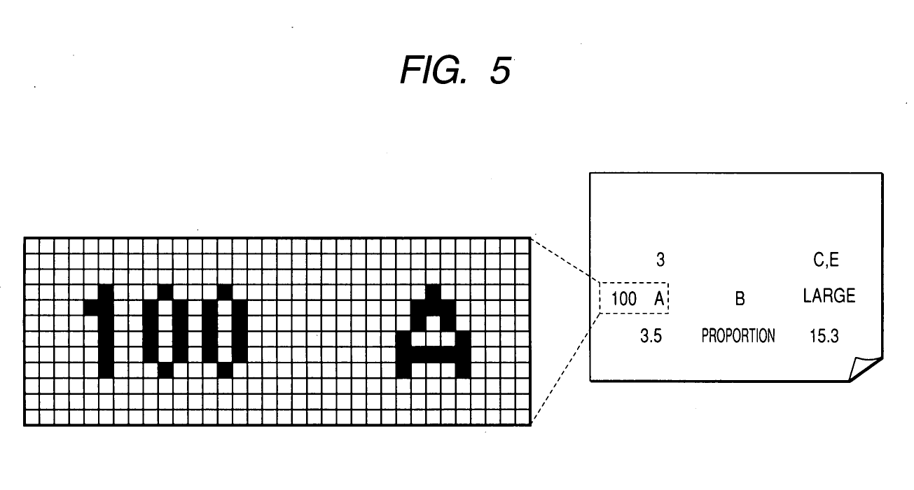

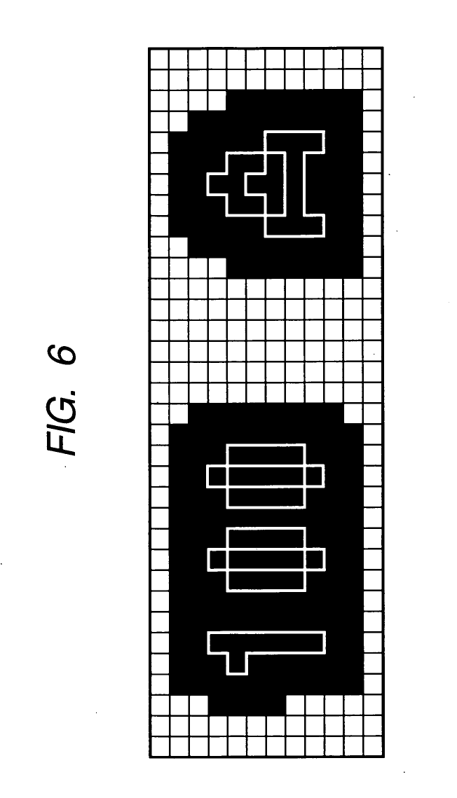

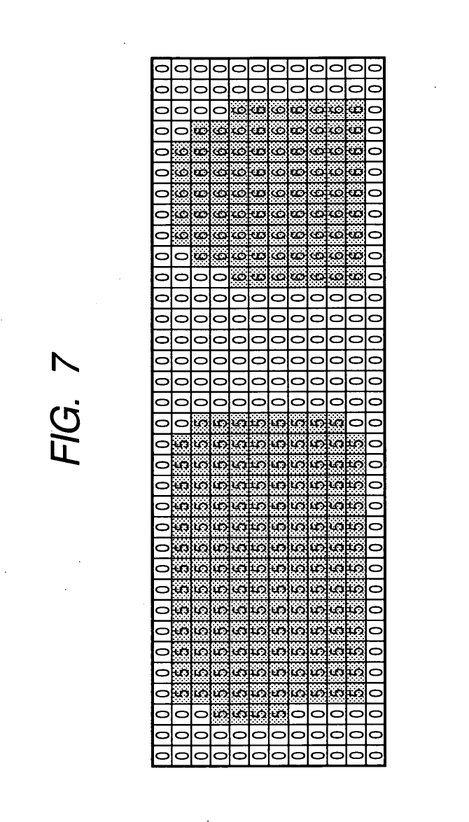

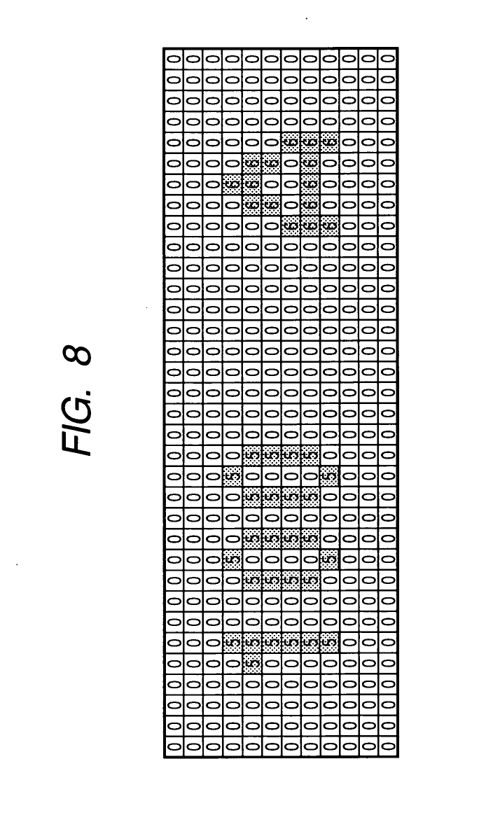

More specifically, first, the grouping unit 41 performs the grouping with respect to the difference extracting result by the difference extracting unit 6. As shown in FIG. 6, at the time of grouping, a predetermined number of pixels (for example, two pixels) are enlarged with respect to the difference extracting result shown in FIG. 5 and ‘an expansion process’ for increasing a size of the pixel segments is performed. After that, as shown in FIG. 7, ‘a labeling process’ for assigning the same number is performed with respect to the segments of the coupled pixels among the segments of the pixels after the expansion process. In addition, as shown in FIG. 8, the number of the pixel, which does not the difference extracting results among the segments of the pixels after the labeling process, is changed to the same number as the background. After performing the process, the pixels assigned with the same number are assumed as the same grouping. If the grouping is performed, the figure ‘100’ exists in the difference extracting result, the difference extracting result is handled with one group without being individually handled with the figures of ‘1’, ‘0’, and ‘0’.

However, the grouping through the grouping unit 41 is not limited to the above-mentioned predetermined rules, that is, performing the expansion process and the labeling process. For example, it may be performed in accordance with another predetermined rule that the segments of the plurality of pixels of segments in which the distance between the segments are not more than a predetermined threshold value is handled with the same group, or the rectangular region is extracted from the layout analyzing result by the image data analyzing unit 3 or the blank portion on the educational teaching material 20 is recognized to determine relevancy between the segments of the plurality of pixels, or relevancy as a word is determined through the character recognition.

In addition, at the time of the grouping, when the question number information 46 is obtained, it is considered that the grouping number is restricted after the grouping in accordance with the question number information 46. The question number information 46 is information that specifies the number of the questions existing on the educational teaching material 20. That is, the question number information 46 is obtained from the database unit 1, is used as the auxiliary information of the division and integration when the grouping is performed, or is used as an index for calculating the reliability of the grouping (probability). As a result, it is possible to improve the process precision of the grouping.

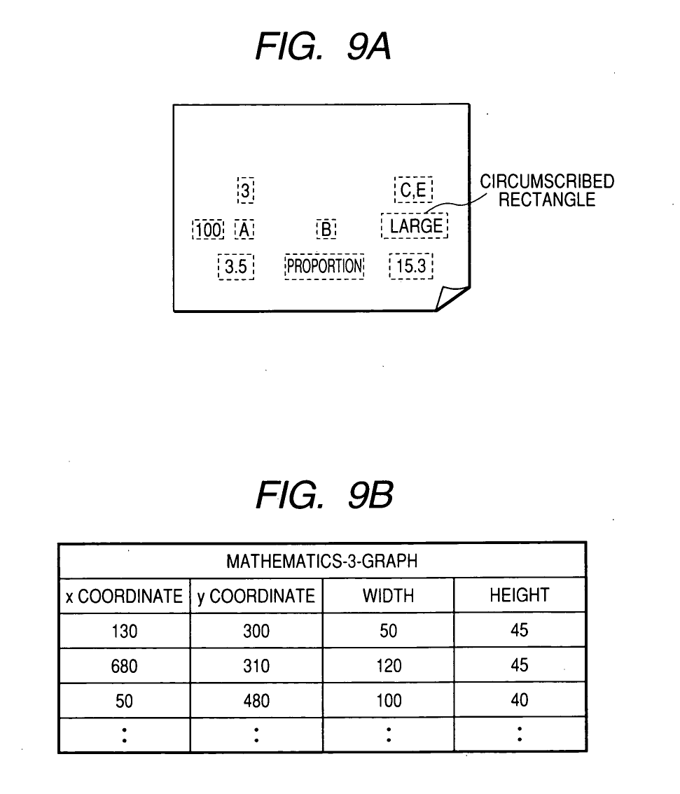

After the grouping by the grouping unit 41, using the result of the grouping, the answer position calculating unit 42 calculates the position information for the answer fields 21 existing on the educational teaching material 20. That is, first, as shown in FIG. 9A, in the answer position calculating unit 42, first, the grouping unit 41 calculates the circumscribed rectangle for each group, and calculates the coordinate position and size of the circumscribed rectangle. Specifically, the maximum value and minimum value of the pixel coordinate in the same group are extracted, the difference between the maximum value and the minimum value is calculated, and the circumscribed rectangle and the position and size of the circumscribed rectangle are calculated. In addition, as shown in FIG. 9B, they are collected in a table type to be assumed as the position information for the answer fields 21 existing on the educational teaching material 20.

On the other hand, the point recognizing unit 43 recognizes the points with respect to the answer fields 21 each of which the position information is calculated by the answer position calculating unit 42. The recognition of the point may use the point information 47 when the point information 47 is obtained from the database unit 1. Here, the point information 47 is information for specifying points that any question (answer field) has. However, when the point information 47 cannot be obtained from the database unit 1, since the point information 24 exists on the educational teaching material 20, the point information 24 may be used. When the point information 24 existing on the educational teaching material 20 is used, entry information made of ‘a figure’ and characters of ‘a point’ is extracted from the image data for the educational teaching material 20 (it may be an original copy and a model answer), and the point may be recognized from the figure portion. Alternatively, the predetermined point through the previous setting may assumed as the entire point or one obtained by dividing the total point by the number of questions may be assumed as the point.

In addition, if the answer position calculating unit 42 calculates the position information of the answer fields 21 and the point recognizing unit 43 recognizes the points with respect to the answer fields 21, the answer/allotted point correspondence information output unit 44 associates the calculation result with the recognition result, and stores and holds it in the database unit 1 as the answer/point correspondence information. At this time, the associating may be performed based on the distances between the positions of the answer fields 21 and the extraction positions of the point information 24. This is a case in which the positions of the answer fields 21 and the extraction positions of the point information 24 located at the shortest distance is associated with each other. The point information 24 is disposed near the answer fields 21 such that the correspondence relationship between the answer fields 21 each of which the point is specified by the point information 24 and the point information 24 is clear.

If the answer/point correspondence information is stored and held in the database unit 1 through the above-mentioned sequence, the point totaling process with respect to the right or wrong determination entered on the educational teaching material 20 can be performed in the teaching material processing apparatus.

In a series of processes described above, when the manual modifying unit 45 is provided, the modification can be made through the manual modifying unit 45 with respect to the calculation result by the answer position calculating unit 42 or the recognition result by the point recognizing unit 43. For example, there is a case in which the region as a candidate of the answer field 21 is displayed as a GUI (graphic user interface) and the user, which had seen it, performs a modifying work on the GUI.

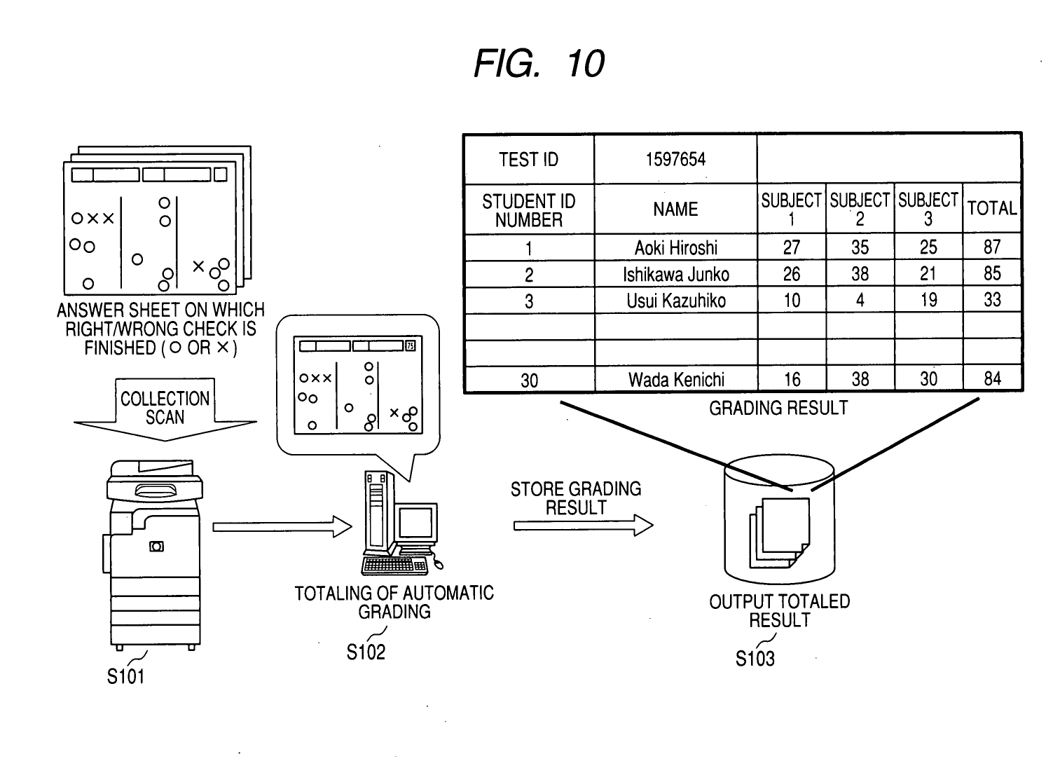

Next, the point totaling process with respect to the right or wrong determination entered on the educational teaching material 20 will be described. FIG. 10 is a diagram illustrating a process operation example of the point totaling process in the teaching material processing apparatus of the invention.

In the point totaling process, first, with respect to the educational teaching material 20 in which the pupil enters a name on the answerer information field 23 and enters answers on the answer fields 21, and the teacher enters figures related to the right or wrong determination such as ‘o’ and ‘x’ with respect to the answers entered on the respective answer fields 21, the image reading unit 2 reads out the image, and obtains the image data from the educational teaching material 20 (step 101, hereinafter, the step is referred to ‘S’). At this time, when the ADF is used, the image reading can be collectively performed with respect to the plurality of teaching materials 20 which are collected in one group like the same class to be processed, so that the image data can be continuously obtained from the respective teaching materials 20. In addition, the image data obtained by the image reading is temporarily held in a memory used as a work area.

Next, the following automatic point totaling process is sequentially performed with respect to the respective image data obtained from the respective teaching materials 20 (S102).

That is, the image data analyzing unit 3 performs the analyzing process with respect to the image data obtained from any one of the teaching materials 20 and the teaching material discriminating unit 4 performs the identification and specification of the educational teaching material 20 based on the result of the analyzing process. The identification and specification may be performed through the title analyzing such as, for example, ‘a science department’, ‘the fifth grade’, and ‘1. a change of weather and temperature’ or code analyzing with respect to embedded code information performed by the teaching material discriminating unit 4. It is possible to specify the electronic data in the database unit 1 becoming the comparison subject of the image data obtained by the image reading unit 2 in the teaching material discriminating unit 4 through the identification and the specification. In addition, the identification and the specification may be sequentially performed with respect to each of the plurality of teaching materials 20 in which the image reading unit 2 performs the image reading. However, generally, since all the teaching materials 20 which are collected in one group to be processed are the same, the identification and the specification may be performed only with respect to the first processed educational teaching material 20 among the plurality of teaching materials which are collected to be processed.

If the teaching material discriminating unit 4 specifies the electronic data, the database unit 1 extracts the corresponding electronic data among the held and stored electronic data in accordance with the specification result, and delivers it to the difference extracting unit 6.

In addition, with respect to the image data obtained from anyone of the teaching materials 20, the distortion correcting unit 5 performs the correction of the image distortion in the image data. The correction of the image distortion is performed for correcting the image distortion occurring when the image is read out by the image reading unit 2, and is performed for executing the comparison between the electronic data or improving the precision of the difference extraction.

In addition, the difference extraction unit 6 compares the electronic data delivered from the database unit 1 with the image data which is obtained by the image reading unit 2 and in which the image distortion has been corrected by the distortion correcting unit 5, and extracts the difference between them. Through the difference extraction, the content of the entry of the answerer information field 23 and the respective answer fields 21 and the content of the entry of the right or wrong determination with respect to the respective answer fields 21 are extracted.

If the difference extracting unit 6 extracts the difference, the answerer specification processing unit 7 specifies the name information with respect to the answerer of the teaching material becoming the reading subject by the image reading unit 2 through the character recognition process or the like with respect to the difference. Thereby, it is possible to specify a class, a student ID number, and a name of the answerer who enters answers on any one educational teaching material 20.

In addition, in order to extract the content of the entry of the right or wrong determination for the respective answer fields 21 with respect to the difference extraction result by the difference extraction unit 6, the right/wrong determination extracting unit 8 extracts, from the difference extraction result, one for the predetermined color component, specifically, one for the red component. The extraction of the predetermined color component may be performed while considering the color component data constituting the pixel data when the difference extraction result is composed of pixel data.

However, generally, the entry of the figures, such as the ‘o’ or ‘x’, on the educational teaching material 20 for performing the right or wrong determination is performed to overlap the questions, frames for specifying the respective answer fields 21, and the content of the answer entry of the respective answer fields 21. For this reason, in the extraction result of the predetermined color component by the right/wrong determination extracting unit 8, there is a fear in that the overlapping portion may be excluded, that is, the disconnection portion may be generated in figures such as ‘o’ or ‘x’. For this reason, with respect to the extraction result of the predetermined color component by the right/wrong determination extracting unit 8, the disconnection correcting unit 9 performs the disconnection correcting process.

Here, the disconnection correction process by the disconnection correcting unit 9 will be described in more detail.

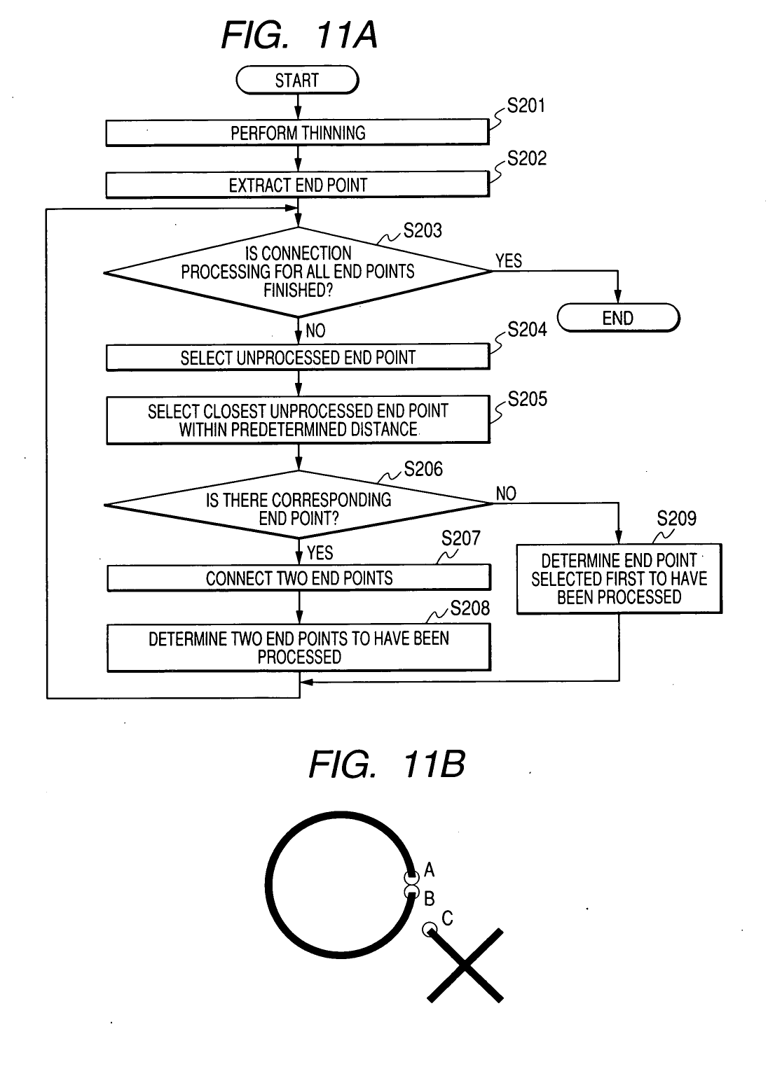

FIGS. 11A-B are a flowchart and a diagram illustrating an example of the disconnection correction process.

In the disconnection correcting process, as shown in FIG. 11A, with respect to the extraction result of the predetermined color component by the right/wrong determination extracting unit 8, that is, with respect to the extraction result which is figures such as ‘o’ or ‘x’, a thinning process is executed (S201), and an end point extracting process is executed (S202). Thereby, when the disconnection portion occurs in the figures, such as ‘o’ or ‘x’, the end points are extracted in the disconnection portion. At this time, since the executed thinning process and the end point extracting process may be executed using the known technology, the detailed description thereof will be described.

In addition, if the end points are extracted, the following process is executed with respect to all the extracted end points (S203). That is, first, one end point which is not processed is selected (S204), and the closest end point (hereinafter, referred to as ‘second end point’) which is not processed is further selected within the predetermined distance from the selected end point (hereinafter, referred to as ‘first end point’) (S205). In addition, when the second end point exists (S206), the first endpoint and the second end point are connected to each other (S207), and it is determined that all the first and second end points are processed (S208). On the other hand, when the second endpoint does not exist (S206), it is determined that the first end point is processed without performing the connection between the end points (S209). This process is performed with respect to the all the end points until the end points, which are not processed, do not exist (S203 to S209).

Thereby, in a case in which the figure shown in FIG. 11b is extracted, even though end points B and C exist within a predetermined distance from an end point A, the nearest end point B from the end point A is connected to the end point A, so that the disconnection portion is corrected in the figure of ‘o’.

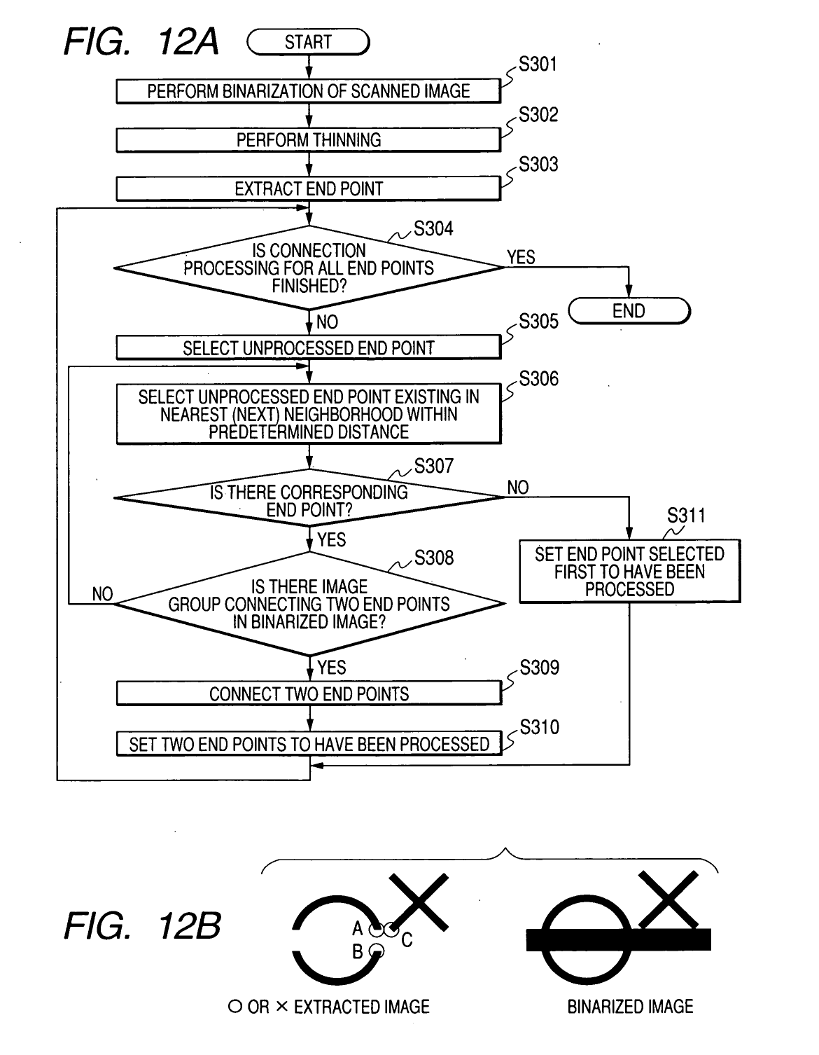

FIGS. 12A-B is a flowchart and a diagram illustrating another example of the disconnection correction process.

In another example of the disconnection correction process, the precision of the disconnection correction process is improved using the image data after the image distortion correction by the distortion correcting unit 5 in addition to the extraction result of the predetermined color component by the right/wrong determination extracting unit 8. That is, in another example of the disconnection correcting process, as shown in FIG. 12A, a binarization process is performed with respect to the image data after the correction of the image distortion by the distortion correcting unit 5 (S301). However, if the binarization process is performed when the difference is extracted by the difference extracting unit 6 or the predetermined color component is extracted by the right/wrong determination extracting unit 8, the image data after the binarization process is performed may be used.

In addition, with respect to the extraction result of the predetermined color component by the right/wrong determination extracting unit 8, a thinning process is executed (S302), and an end point extracting process is executed (S303). In addition, if the end points are extracted, the following process is performed with respect to all the extracted endpoints (S304).

First, one end point which is not processed is selected (S305), and the nearest end point which is not processed is further selected as a second end point within the predetermined distance from one selected end point (S306). In addition, when the second end point exists (S307), it is determined whether a pixel group for connecting the first end point and the second endpoint exists in the image data after the binarization process (S308). That is, it is to determine whether an overlapping portion becoming a main factor of the disconnection occurrence exists. As a result, if the overlapping portion exists, the first end point and the second end point are connected to each other (S309), and it is set that all the first and second end points are processed (S310). On the other hand, when the overlapping portion does not exist, the process returns to the above-mentioned step (S306), and an end point, which is within the predetermined distance from the first end point and is most adjacent to the nearest end point from the first end point, is selected as a second end point. At this time, when the end point to be selected does not exist, it is set that the first end is processed, without performing the connection between the end points (S311). This process is performed with respect to the all the end points until the end points, which are not processed, do not exist (S304 to S311).

Thereby, in a case in which the figure shown in FIG. 12B is extracted, if endpoints B and C exist within a predetermined distance from an end point A, the nearest end point C from the end point A is selected from the end points B and C. However, since a pixel group for connecting the end points A and C does not exist in the image data after the binarization process, the end points A and C are not connected to each other. In addition, if the end point B, which is within the predetermined distance from the end point A and is adjacent to the end point A next to the end point C, is selected, since a pixel group does exist between the end points B and A in the image data after the binarization process, the end point B is connected to the end point A. That is, the disconnection portion is corrected in the figure of ‘o’ without ‘o’ and ‘x’ being erroneously connected.

After performing the disconnection correcting process by the above-mentioned disconnection correcting unit 9, the figure shape recognizing unit 10 performs the shape recognition with respect to the content of the entry of the right or wrong determination, that is, performs a pattern matching with the figure shape of ‘o’ or ‘x’, and it is recognized whether the content of the entry of the right or wrong determination is ‘correct’ or ‘incorrect’. Since the pattern matching executed at this time can be executed by using the known technology, the detailed description thereof will be omitted.

In addition, if the figure shape recognizing unit 10 performs the shape recognition with respect to the content of the entry of the right or wrong determination, the entry position recognizing unit 11 recognizes the entry position on the educational teaching material 20 with respect to the content of the entry of the right or wrong determination. In addition, in order to collect continuous pixel groups constituting the figures of ‘o’ or ‘x’ to be handled with one when the shape is recognized by the figure shape recognizing unit 10, the labeling process which is a general image processing technology is performed so as to give an identifier to the continuous pixel groups. For this reason, even when the position recognition is performed by the entry position recognizing unit 11, the continuous pixel groups constituting the figures of ‘o’ or ‘x’ are handled with one collection using the result of the labeling process.

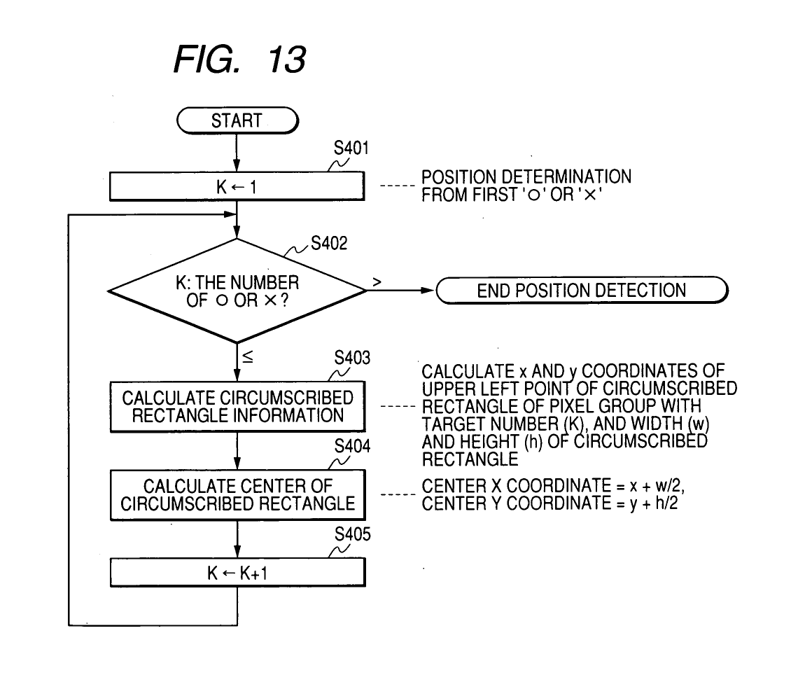

Here, the recognition process of the right or wrong determination entry position by the entry position recognizing unit 11 will be described in more detail. FIG. 13 is a flowchart illustrating an example of the recognition process sequence of the right or wrong determination entry position.

In the recognition process of the right or wrong determination entry position, since the plurality of right or wrong determination are entered on the educational teaching material 20, a count number K with respect to the right or wrong determination is set to ‘1’ (S401). Thereby, until the number of the count K exceeds the number of the right or wrong determination existing on the educational teaching material 20, that is, the number of the answer fields 21 (S402), the position is sequentially recognized with respect to the right or wrong determination (figures of ‘o’ or ‘x’) detected at the predetermined scanning lines.

The position recognition may be performed by calculating circumscribed rectangle information of the figures of ‘o’ or ‘x’ (S403) and calculating a center coordinate of the circumscribed rectangle (S404). More specifically, the circumscribed rectangle is extracted with respect to the figures (continuous pixel groups) becoming the recognition subject, and x and y coordinates of the predetermined point of the circumscribed rectangle (for example, a top point of an upper left) and a width (w) and height (h) of the circumscribed rectangle are calculated. In addition, a center x coordinate x+w/2 and a center y coordinate=y+h/2 are calculated from the calculation result, and the calculation result is set to the positions of the continuous pixel groups, that is, the recognition result of the right or wrong determination entry position.

This process is repeated while incrementing the value of the number of the count K (S405) until the recognition is finished with respect to all the right or wrong determination existing on the educational teaching material 20 (S402 to 405).

As such, after the entry position recognizing unit 11 recognizes the right or wrong determination entry position, the point totaling unit 13 performs the point totaling of the right or wrong determination. At this time, the point totaling unit 13 performs the point totaling based on the recognition result of the entry position of the right or wrong determination by the figure shape recognizing unit 10, the recognition result of the entry position of the right or wrong determination by the entry position recognizing unit 11, and the answer/point correspondence information which the database unit 1 holds and accumulates.

However, the entry of the right or wrong determination is generally performed to correspond to the respective answer fields 21 existing on the educational teaching material 20, but is performed by the manual entry of the teacher. Therefore, the entry positions with respect to the respective answer fields 21 are not necessarily determined in one manner.

On the other hand, in the point totaling of the right or wrong determination, it is necessary that the correspondence relationships between the respective answer fields 21 and the entry positions of the right or wrong determination be clear. After making the entry result of the right or wrong determination corresponding to the respective answer fields 21 clear, the point totaling of the right or wrong determination is performed based on the content of the right or wrong determination (right or wrong) and the point with respect to the respective answer fields 21.

As a result, in the point totaling unit 13, the point totaling of the right or wrong determination is performed in accordance with the sequence described below. That is, the point totaling unit 13 calculates an overlapping area between the circumscribed rectangles of the right or wrong determination figures such as ‘o’ or ‘x’ and a region becoming the answer fields 21 on the educational teaching material 20, associates the right or wrong determination figures and the answer fields 21 having the largest overlapping area (equal in the area ratio with respect to the circumscribed rectangle) with each other, and sets the right or wrong determination figures to the right or wrong determination result entered on the corresponding answer fields 21. However, when the ratio of the overlapping area to the circumscribed rectangle is less than a predetermined threshold value, the overlapping portion is small, and thus it is determined that the determination with respect to the association is unable. In addition, after the association is performed, if the right or wrong determination figure is ‘o’, the point specified from the point information with respect to the corresponding answer field 21 is added, and if the right or wrong determination figure is ‘x’, the point totaling is performed with respect to all the answer fields 21 on the educational teaching material 20 without adding the point with respect to the corresponding answer field 21. In addition, the region becoming the answer fields 21 on the educational teaching material 20 may be specified by the answer/point correspondence information with respect to the respective answer fields 21.

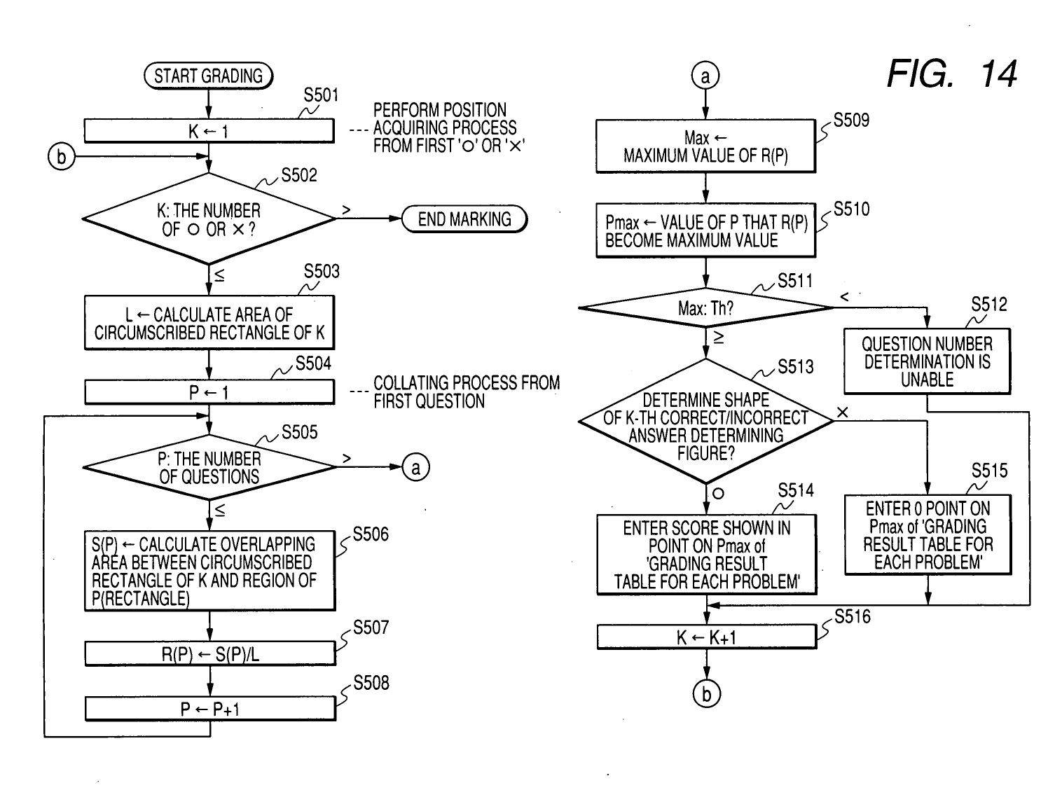

Here, the point totaling of the right or wrong determination by the point totaling unit 13 will be described in more detail. FIG. 14 is a flowchart illustrating an example of the process sequence of the point totaling of the right or wrong determination.

In the point totaling of the right or wrong determination, since the plurality of right or wrong determination are entered on the educational teaching material 20, the number of the count K with respect to the right or wrong determination is set to ‘1’ (S501). Thereby, until the number of the count K exceeds the number of the right or wrong determination existing on the educational teaching material 20, that is, the number of the answer fields 21 (S502), the point totaling process is sequentially performed with respect to the right or wrong determination (figures such as ‘o’ or ‘x’) detected at the predetermined scanning lines.

That is, an area of the circumscribed rectangle is calculated with respect to the figure of the K-th ‘o’ or ‘x’ and it is then set to ‘L’ (S503). In addition, the number of the count P with respect to the number of the answer fields 21 (=the number of questions) is set to ‘1’ (S504), and if the count number P is not more than the number of questions existing on the educational teaching material 20 (S505), the answer field position region information with respect to the answer field 21 is extracted. In addition, an area where the K-th circumscribed rectangle and the P-th area overlap is calculated, and the calculation result is set to ‘S(P)’ (S506). Further, the ratio between the overlapping area S(P) and the area of the circumscribed rectangle L is calculated, and is set to ‘R(P)’ (S507). This process is repeated while incrementing the value of the number of the count P (S508) until the process is finished with respect to all the answer field position region information (S505 to S508).

Next, a maximum value of the ratio R (P) is calculated and is set to ‘Max’ (S509), and the value of the number of the count P that the overlapping area S(P) becomes the maximum is calculated and is set to ‘Pmax’ (S510). In addition, when the value of the maximum value Max is less than a predetermined threshold value Th (S511), the association between the right or wrong determination figure and the answer field 21 becomes unable, and it is determined that the question number corresponding to the right or wrong determination figuration is unclear (S512). To the contrary, if the value of the maximum value Max is not less than the predetermined value Th (S511), it is determined that the K-th right or wrong determination figure is ‘o’ or ‘x’ (S513). As a result, if the K-th right or wrong determination figure is ‘o’, in ‘a grading result for each question’, the point with respect to the answer of the question of the number of the count Pmax is added (S514). In addition, if the K-th right or wrong determination figure is ‘x’, it is set to ‘0 point’ without adding the point with respect to the answer of the question of the number of the count Pmax (S515).

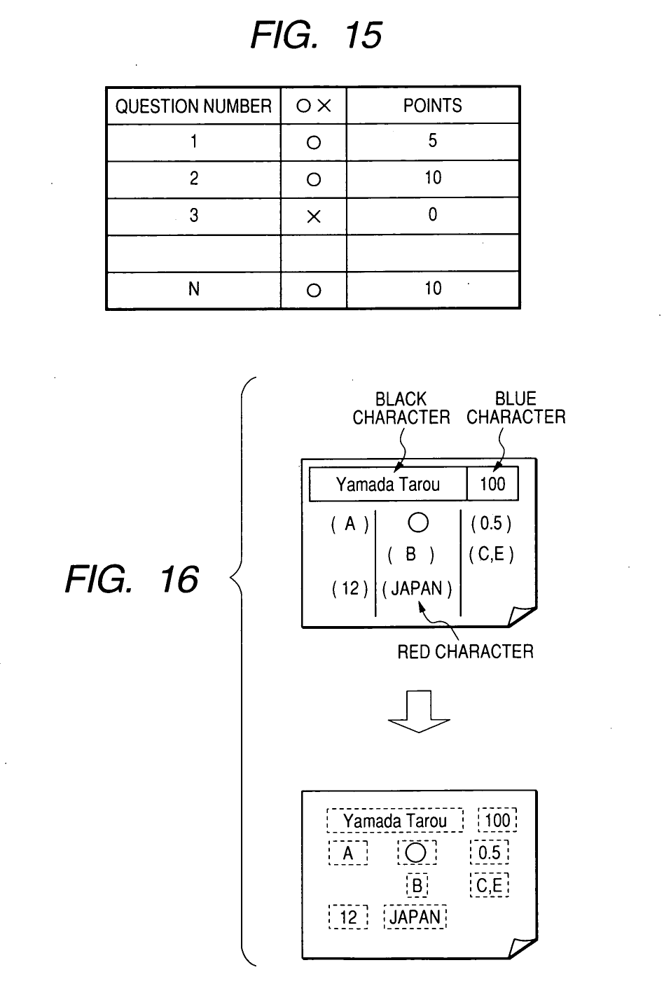

In addition, this process is repeated while incrementing the value of the number of the count K (S516) until the process is finished with respect to all the right or wrong determination existing on the educational teaching material 20 (S502 to S515) Through the above-mentioned process, the result of the point totaling of the right or wrong determination entered on the educational teaching material 20 is outputted as the grading result for each question from the point totaling unit 13. FIG. 15 is a diagram illustrating one specified example of the grading result for each question. The grading result for each question is information composed of the number of the question existing on the educational teaching material 20, the right or wrong determination with respect to the answer of the question, and a point based on the right or wrong determination, and the grading result for each question is outputted from the point totaling unit 13 in a table type that the number of the question, the right or wrong determination, and the point are associated with each other, as shown in FIG. 15.

If the grading result for each question is outputted from the point totaling unit 13, the totaled result output unit 14 associates the grading result for each question, that is, the result of the point totaling by the point totaling unit 13 with the answer information extracted by the answerer extracting unit 7, and outputs it to the database device 31 or the file server device 32 connected to the teaching material processing apparatus (S103 in FIG. 10). Thereby, in the database device 31 or the file server device 32, it is possible to manage or use the grading totaled result with respect to the educational teaching material 20 in a table type.

As described above, in the teaching material processing apparatus, the teaching material processing method and the teaching material processing program according to the present embodiment, the image data readout from the educational teaching material 20 in which the entry of the right or wrong determination is made is compared with the electronic data with respect to the educational teaching material 20, that is, the data with respect to the original copy in which the answer entry of the answer fields 21 and the entry of the right or wrong determination with respect to the corresponding answers are not made, the content of the entry of the right or wrong determination is recognized from the difference between the image data and the electronic data, and the point totaling of the right or wrong determination is performed. Therefore, if the image reading is performed with respect to the educational teaching material 20 in which the entry of the right or wrong determination is made, the automatic totaling of the grading result is performed with respect to the entered right and wrong determination. As a result, the grading process with respect to the educational teaching material 20 is omitted. Moreover, since the process is based on the image data read out from the educational teaching material 20, if there are a scanning function achieved by a copy machine, a multi-functional machine or a scanner device, and an information storage processing function, an image processing function and an operation processing function which a computer device such as a PC has, the device configuration can be achieved, so that it is not necessary to provide the dedicated configuration device. Further, since the image data read out from the educational teaching material 20 is compared with the electronic data held in the database unit 1, if the electronic data with respect to various teaching materials 20 is held and accumulated in the database unit 1, versatility for the teaching materials can be sufficiently ensured.

In addition, in the teaching material processing apparatus, the teaching material processing method, and the teaching material processing program according to the present embodiment, the position information for the answer fields 21 which the educational teaching material 20 has is calculated based on the difference between the image data obtained from the educational teaching material 20 in which the entry of the answer fields 21 such as the model answer is finished and the image data obtained from the original copy in which the entry of the answer fields 21 is not finished by the reading means, and the calculated result is associated with the recognition result of the points with respect to the answer fields 21 and is then held and stored in the database unit 1 as the answer/point correspondence information. That is, the answer/point correspondence information is obtained based on the difference between the model answer and the original copy, is stored and held in the database unit 1, and is used at the time of the following point totaling process. Therefore, even when the plurality of questions and the answer fields thereof 21 are disposed on the educational teaching material 20, and the points for the respective questions are different from each other, since the correspondence relationships between the respective answer fields 21 and the points for the respective answer units are obvious on the basis of the answer/point correspondence information which the database unit 1 stores, the point totaling unit 13 can suitably perform the point totaling with respect to the right or wrong determination. In addition, since the answer/point correspondence information is extracted and created from the difference of the image reading result with respect to the model answer and the original copy, it is not necessary that the position information of the answer fields 21 is manually inputted before the point totaling is performed.

That is, according to the teaching material processing apparatus, the teaching material processing method, and the teaching material processing program of the present embodiment, since the automatic point totaling with respect to the content of the entry of the right or wrong determination can be performed while reducing the troublesomeness such as the information input with respect to the educational teaching material 20 used in the educational institutions, the grading process can be performed more easily. Therefore, the grading process, which is used in the education institutions very often, can be smoothly performed with high reliability.

In addition, according to the teaching material processing apparatus, the teaching material processing method, and the teaching material processing program in the present embodiment, in the recognition process of the answer/point correspondence information, with respect to the extraction result of the difference between the model answer and the original copy, the grouping for classifying the extraction result according to the predetermined rule is performed, and the answer fields 21 existing on the educational teaching material 20 can be specified using the result of the grouping process. Therefore, even when a figure ‘100’ exists on the difference extracting result between the model answer and the original copy, by performing the grouping, the difference extracting result can be handled with one group without being handled with individual figures of ‘1’, ‘0’, and ‘0’. That is, even when the position information of the answer fields 21 is calculated from the difference extracting result between the model answer and the original copy, the calculation precision can be improved. As a result, it is possible to perform the grading process with high reliability.

In addition, in the present embodiment, the preferred specific examples of the invention are described, but the invention is not limited thereto. For example, the above-mentioned distortion correcting process or the disconnection correcting process is not necessarily performed. Further, while the marking of test papers is done to enter the figure (◯) for a correct answer and the figure (X) for an incorrect answer in the embodiment as above, another figures may be used. For example, a check mark can be used for a correct answer.

In the present embodiment, the case in which the position information of the answer fields 21 is calculated from the difference extracting result between the model answer and the original copy has been described. However, since the answerer information field 23 as the entry field as well as the answer fields 21 exists on the educational teaching material 20, not only the position information of the answer fields 21 but also the position information of the answerer information field 23 can be calculated, and the difference between the answer field 21 and the answerer information field 23 can be recognized from the difference extracting result, that is, the difference between the properties of the entry fields on the educational teaching material 20 can be recognized.

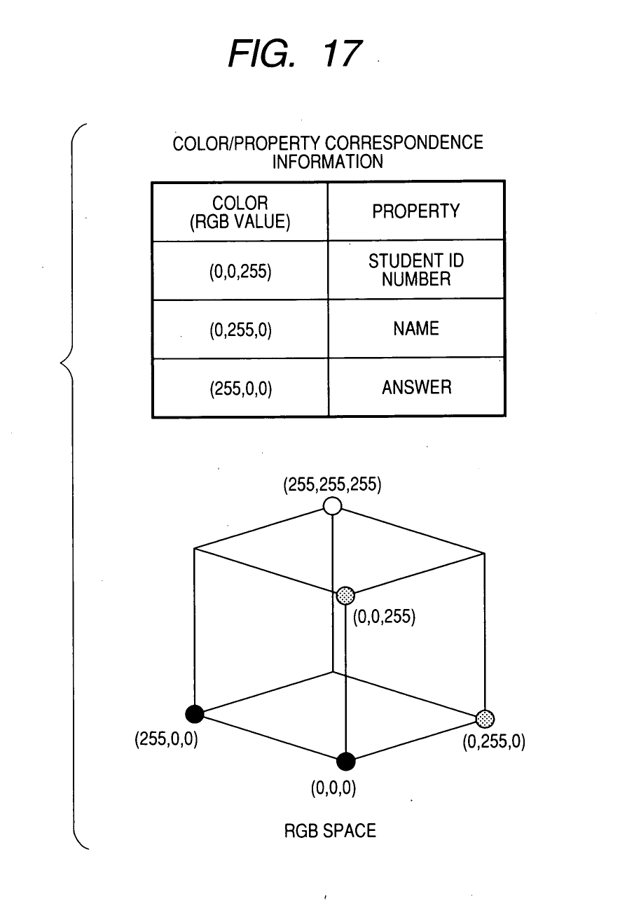

Here, the case in which the difference between the prosperities of the entry fields is recognized will be described through the specific example. FIGS. 16 and 17 are diagrams illustrating the outline of the recognition example of the difference between the properties of the entry fields.

When the difference between the properties of the entry fields is recognized, the image data of the original copy and the answer in which the entry of the answers is finished is obtained. However, as shown in FIG. 16, on the answers in which the entry of the answers is finished, the answerer name field is displayed with a black character, the point field is displayed with a blue character, and the answer field is displayed with a red character. Like this, the entered character colors are different from each other in accordance with the respective properties. In addition, the position information of the respective entry fields is calculated from the difference extracting result between the original copy and the answer in which the entry of the answers is finished, the color data component is extracted from the difference extraction result, the extraction result is collated with the color/property correspondence information shown in FIG. 17, and the difference between the properties of the respective entry fields is recognized from the collating result. If the difference between the properties of the respective entry fields is recognized, the extractions of the answerer name or the point as well as the answer become considerably easy. This means that if the plurality of entry fields each having a different property exist, it can be applicable to another sheet as well as the educational teaching material 20.

However, in the recognition of the difference between the prosperities of the entry fields, the recognition may be performed based on another data component without being performed based on the color data component. More specifically, the difference between the sizes of the entry characters is recognized through a skeletonization process (a process for thinning the line step by step), and when the figure of the predetermined shape (◯ or □) is entered in the entry fields, the shape of the figure is recognized.

In addition, the invention is not limited to the above-mentioned embodiment, and various changes and modifications can be made without departing from the spirit and scope of the invention.

What is claimed is:

1. A material processing apparatus comprising:
a reading unit that performs image reading on materials each having an entry field, to obtain image data from the materials;
an extracting unit that compares image data for one material on which a content of the entry field is entered with image data for one material on which a content of the entry field is not entered, and extracts a difference between the image data;
a calculating unit that calculates position information for the entry field existing on the material from an extracted result by the extracting unit;
a memory that stores a result calculated by the calculating unit;
a recognizing unit that extracts a content of the entry of the correct/incorrect determination with respect to the entry of the entry field from the image data obtained by the reading unit; and
a point totaling unit that performs point totaling of the correct/incorrect determination entered on the material based on a stored content by the memory and the extracted result by the recognizing unit.

2. The material processing apparatus according to claim 1,
wherein the calculating unit calculates position information for an answer entry field for a question in the entry field;
the memory associates the calculated result by the calculating unit with points distributed to the answer entry fields whose position information is calculated by the calculating unit so as to be stored as answer/point correspondence information; and
the recognizing unit extracts contents of the entry of the correct/incorrect determination for the material.

3. The material processing apparatus according to claim 1,
wherein the calculating unit performs a grouping process to classify an extracted result by the additionally entered information extracting unit in accordance with a predetermined rule and specifies the entry field existing on the material using the result of grouping process.

4. The material processing apparatus according to claim 1,
wherein when the material has a plurality of entry fields each different in properties, the calculating unit recognizes a difference between the properties based on a predetermined data component among the difference extracted by the extracting unit.

5. A material processing method comprising:
reading image on materials each having an entry field, to obtain image data from the materials;
comparing image data for one material on which a content of the entry field is entered with image data for one material on which a content of the entry field is not entered;
extracting a difference between the image data;
calculating position information for the entry field existing on the material from an extracted result in the extracting step;
storing a result calculated in the calculating step;
extracting a content of the entry of the correct/incorrect determination with respect to the entry of the entry field from the image data obtained in the reading step; and
performing point totaling of the correct/incorrect determination entered on the material based on a stored content in the storing step and the extracted result in the step of extracting the content of the entry of the correct/incorrect determination.

6. The material processing method according to claim 5,
wherein the calculating step includes calculating position information for an answer entry field for a question in the entry field;
the storing step includes associating the calculated result by the calculating step with points distributed to the answer entry fields whose position information is calculated by the calculating step so as to be stored as answer/point correspondence information; and
the step of extracting the content of the entry of the correct/incorrect determination includes extracting contents of the entry of the correct/incorrect determination for the material.

7. The material processing method according to claim 5,
wherein the calculating step includes performing a grouping process to classify an extracted result by the extracting step in accordance with a predetermined rule and specifying the entry field existing on the material using the result of grouping process.

8. The material processing method according to claim 5,
wherein when the material has a plurality of entry fields each different in properties, the calculating step includes recognizing a difference between the properties based on a predetermined data component among the difference extracted by the extracting step.

9. A storage medium readable by a computer, the storage medium storing a program of instructions executable by the computer to perform a function, the function comprising:
reading image on materials each having an entry field, to obtain image data from the materials;
comparing image data for one material on which a content of the entry field is entered with image data for one material on which a content of the entry field is not entered;
extracting a difference between the image data;
calculating position information for the entry field existing on the material from an extracted result in the extracting step;
storing a result calculated in the calculating step;
extracting a content of the entry of the correct/incorrect determination with respect to the entry of the entry field from the image data obtained in the reading step; and
performing point totaling of the correct/incorrect determination entered on the material based on a stored content in the storing step and the extracted result in the step of extracting the content of the entry of the correct/incorrect determination.

10. The storage medium according to claim 9,
wherein the calculating step includes calculating position information for an answer entry field for a question in the entry field;
the storing step includes associating the calculated result by the calculating step with points distributed to the answer entry fields whose position information is calculated by the calculating step so as to be stored as answer/point correspondence information; and
the step of extracting the content of the entry of the correct/incorrect determination includes extracting contents of the entry of the correct/incorrect determination for the material.

11. The storage medium according to claim 9,
wherein the calculating step includes performing a grouping process to classify an extracted result by the extracting step in accordance with a predetermined rule and specifying the entry field existing on the material using the result of grouping process.

12. The storage medium according to claim 9,
wherein when the material has a plurality of entry fields each different in properties, the calculating step includes recognizing a difference between the properties based on a predetermined data component among the difference extracted by the extracting step.
